(19) United States
(12) Patent Application Publication
(10) Pub. No.: US 2020/0250655 A1
(43) Pub. Date: Aug. 6, 2020

(54) EFFICIENT, ENVIRONMENTAL AND CONSUMER FRIENDLY CONSENSUS METHOD FOR CRYPTOGRAPHIC TRANSACTIONS

(71) Applicant: Sensoriant, Inc., Cedar Knolls, NJ (US)

(72) Inventors: Shamim A. Naqvi, Morristown, NJ (US); Robert F. Raucci, New York, NY (US)

(21) Appl. No.: 16/778,247

(22) Filed: Jan. 31, 2020

Related U.S. Application Data
(60) Provisional application No. 62/799,362, filed on Jan. 31, 2019.

(51) Int. Cl. G06Q 20/36; G06Q 20/38; G06Q 20/32

(52) U.S. Cl. CPC G06Q 20/3674; G06Q 20/3223; G06Q 20/38215

(57) ABSTRACT

In accordance with a method of verifying a transaction between a user communication device and a third party, a request is received at each of a plurality of elector nodes to verify the transaction. A leader node is selected from among the elector nodes using a Proof of Elapsed Time (PoET) consensus decision-making algorithm in which each of the elector nodes is assigned a random wait time, the leader node being a first of the elector nodes whose wait time is exceeded. The leader node is used to select a subset of verifier nodes from among a plurality of verifier nodes in accordance with a second consensus decision-making algorithms different from the PoET consensus decision-making algorithm. The leader node is used to select a given verifier node from among the subset of nodes. The given verifier node is caused to verify the transaction.

### BACKGROUND

Transaction processing systems occupy a central role in modern computing technology and use cases abound in many facets of society. Considerable emphasis has been placed on various aspects of transaction technology to improve, e.g., latency and performance of transaction systems, integrity of payment data, etc. A salient concern is that of consumers demanding privacy regarding the details of their transactions, e.g., their payment credentials, locations where goods or services were purchased, etc. This concern is exacerbated when certain transactions require consumers to submit personal details as a part of a transaction, e.g., submitting a street address or proof of age, etc. The number of kinds of transactions requiring personal information from users is increasing, especially in online commerce. For example, many online transactions involving goods to be delivered to a customer require a street address. Sports gaming websites require proof of age, citizenship and address. Alcohol purchases and computer game stores are required by regulators to ask customers for proof of age and residence. Know Your Customer (KYC), General Data Protection Regulation (GDPR) and Anti-Money Laundering (AML) regulations require consumers to produce information and for merchants to protect such information in various ways.

In cryptographic systems, e.g., cryptographic currencies, technologists have proposed various anonymity schemes based on cryptographic technologies that protect the identity of consumers. Such techniques, however, have an unwanted consequence, viz., certain consumers engage in illicit transactions, e.g., purchase of illicit goods, or fail to pay taxes and flout regulations. Increasingly, anonymity-based transaction schemes are being subjected to increased scrutiny by regulators. Generally, governments require taxes to be paid by cryptographic transactions in a manner similar to fiat currency transactions.

In U.S. patent application Ser. No. 16/006,966, U.S. Ser. No. 16/036,012 and U.S. Ser. No. 16/160,284, various technologies have been presented that capture user information and convert them into cryptographic credentials that are inscrutable. When shared with, e.g., merchants, the cryptographic credentials may be verified by the recipients (or agents acting on behalf of the recipients) without recourse to the underlying user information. As a simple example, a consumer's date of birth data may be converted (using a given computer program) into a cryptographic credential that the consumer is more than 18 years old. The latter credential may then be transmitted to a merchant who is then enabled by cryptographic technology to verify the received credential without possessing the originator's date of birth data. Such techniques were collectively labeled as selective anonymity in the applications cited above.

Using the technology of selective anonymity, consumers may thus reveal selected aspects of their profiles to, inter alia, merchants whilst protecting their personal data. The merchants benefit from receiving consumer information that they are required to collect on behalf of regulators and, additionally, being able to verify that the submitted data. Furthermore, since the merchants may choose not to receive any user data (and choose to only receive cryptographic credentials derived from it that are inscrutable), they are, by definition, compliant with GDPR and KYC regulations.

The cryptographic techniques that convert user information into verifiable cryptographic credentials may also be used, as shown in the patent applications cited above, to convert spending rights of consumers into cryptographic credentials of a particular type. For example, a user may provide fiat currency to an exchange provider who may then run a pre-determined computer program to produce a corresponding cryptographic credential. That is, the technology produces a verifiable link between the computer program to which the fiat currency was input and its output, i.e., a pair of elements comprising cryptographic currency and a “proof” of the execution of the program.

Thus, this technology may be used as a basis for a cryptocurrency in which the cryptographic credentials not only contain payment information based on the spending rights of users but may also contain the sender's personal information.

It is important to understand that the technology of selective anonymity links computer programs with the cryptographic credentials derived from the underlying user data. Consider, by way of example, the afore-mentioned “age>18” cryptographic credential derived from a user's date of birth by using a particular computer program. To verify this cryptographic credential, a verifier needs to ensure that the latter was produced by a verifiable execution of the known computer program operating on an input. That is, the verifier needs to verify the link between the input to the computer program, the computer program and the cryptographic credential.

### SUMMARY

In one aspect, a method and apparatus is presented of verifying a transaction between a user communication device and a third party. In accordance with the method, a request is received at each of a plurality of elector nodes to verify a transaction. A leader node is selected from among the elector nodes using a Proof of Elapsed Time (PoET) consensus decision-making algorithm in which each of the elector nodes is assigned a random wait time, the leader node being a first of the elector nodes whose wait time is exceeded. The leader node is used to select a subset of verifier nodes from among a plurality of verifier nodes in accordance with a second consensus decision-making algorithms different from the PoET consensus decision-making algorithm. The leader node is used to select a given verifier node from among the subset of nodes. The given verifier node is caused to verify the transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one example of an environment in which a cryptocurrency transaction may be performed between a user communication device and a third party.

FIG. 2 a schematic block diagram of the components used to generate and verify the cryptographic coins or token and the various cryptographic keys used in one example of the proof of zero knowledge protocol.

FIG. 3 shows an exemplary cryptographic coin comprising a spending right cryptographic credential and a user data cryptographic credential.

FIG. 4 shows one particular implementation of the cryptocurrency environment of FIG. 1 in which the cryptocurrency that is employed is based on the coins or tokens in which spending rights are incorporated in verifiable cryptographic credentials.

FIG. 5 shows one example of an operating environment in which the consensus techniques described herein may operate.

FIG. 6 is a flowchart illustrating one example of a method for verifying a transaction between a user communication device and a third party.

### DETAILED DESCRIPTION

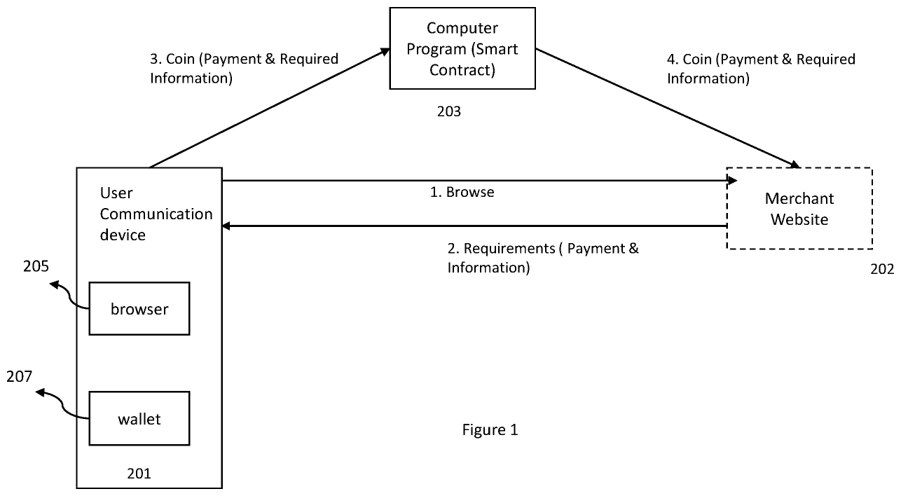

FIG. 1 shows one example of an environment in which a cryptocurrency transaction may be performed between a user communication device 201 (e.g., a mobile or wireless communication device such as a smartphone) and a third party. For purposes of illustration and not as a limitation on the techniques described herein the third party will be referred to as a merchant having a merchant device 202 (e.g., a merchant website, a merchant point-of-service terminal) and the transaction will be described as a transaction to purchase a good or service. More generally, however, any type of transaction may be conducted between the parties. The example of FIG. 1 shows the execution of a two-legged transaction that employs a smart contract 203 to mediate the transaction. Smart contracts are computer programs that both express the contents of a contractual agreement and operate to implement the content, based on triggers that may be provided, for instance, by the users of the smart contract or extracted from a blockchain environment.

A browser 205 or other application on the user communication device 201 is used to browse the merchant website 202 (step 1). The browsing activity results in the consumer being made aware of the information and the payment needed for various goods and services (step 2). The consumer may now issue commands to begin the transaction. A digital wallet 207 on the user communication device 201 may extract or create as needed an amount of cryptocurrency (i.e., a payment value) that is incorporated in a data object referred to herein as a coin or token. The terms coin and token will be used interchangeably herein. The coin and any necessary associated user information is transmitted to the smart contract 203 (step 3). Step 3 may be said to comprise the first leg of the transaction. The smart contact may now verify the payment and information components of the received coin and, upon successful verification, initiate a transaction with the merchant device 202 (step 4). Step 4 may be said to comprise the second leg of the transaction. Finally, the smart contract may optionally record the transaction in a distributed ledger such as a blockchain (not shown in FIG. 1). If the blockchain record is examined, it may show two transactions, the first initiated by the user communication device 201 and the second initiated by the smart contact 203.

It should be noted that FIG. 1 represents only one illustrative example of a method for implementing a cryptocurrency transaction using a smart contract. However, the techniques and systems described herein more generally may be used in conjunction with other methods of implementing cryptocurrency transactions that may or may not employ smart contracts. For instance, in some cases a payment service may be employed instead of a smart contract. In other cases, the cryptocurrency transaction may be conducted directly between the user communication device 201 and the merchant device 202 without the use of a third party or smart contract.

A brief description of the cryptographic techniques used to generate this cryptocurrency coin or token will now be presented. Additional details may be found in U.S. patent application Ser. No. 16/006,966, Ser. No. 16/036,012 and Ser. No. 16/160,284, which are incorporated herein by reference.

In general, these techniques employ a computer program ƒ that encapsulates a spending right (a cryptocurrency amount or payment) to perform a transaction. Such programs are referred to herein as cryptographic transaction programs. For instance, one illustrative cryptographic transaction computer program ƒ₁ described in the aforementioned U.S. Patent Applications generates a coin or token that transfers a spending right between two communication devices. Another illustrative cryptographic transaction computer program ƒ₂ splits a spending right and transfers one part of the spending right while retaining the other part. Yet another illustrative cryptographic transaction computer program ƒ₃ takes as input two spending rights embodied in two different tokens and generates a single token that embodies the sum of the two individual spending rights.

One important aspect of this technique for generating a coin or token is that it also generates a proof that can be used to verify that the cryptographic transaction computer program ƒ performed the transaction using the spending right. The cryptographic coin or token, along with the proof, is referred to herein as a cryptographic credential. The two components of the cryptographic credential may be generated using the following encryption scheme.

An encryption scheme is a triple (G, E, D) where “G” is a computer program called the key generator (or key generating engine), “E” is a computer program called the encryption engine and “D” is a computer program called the decryption engine. For every (e, d) in the range of G and for every α∈(0,1)*, computer programs E (encryption) and D (decryption) satisfy Probability[D(d,E(e,α))=α]=1. In words, any bit string encrypted by the computer program E can be decrypted by the computer program D. The string E(e, α)=β is the encryption of the plaintext a using the encryption e whereas D(d, β) is the decryption of β using the decryption key d. In a public key scheme, e≠d; in a private key scheme e=d. The elements of the pair (e, d) are called encryption and decryption keys, respectively. Further details can be found in O. Goldreich, Foundations of Cryptography, Vol. 2, Cambridge University Press, 2004.

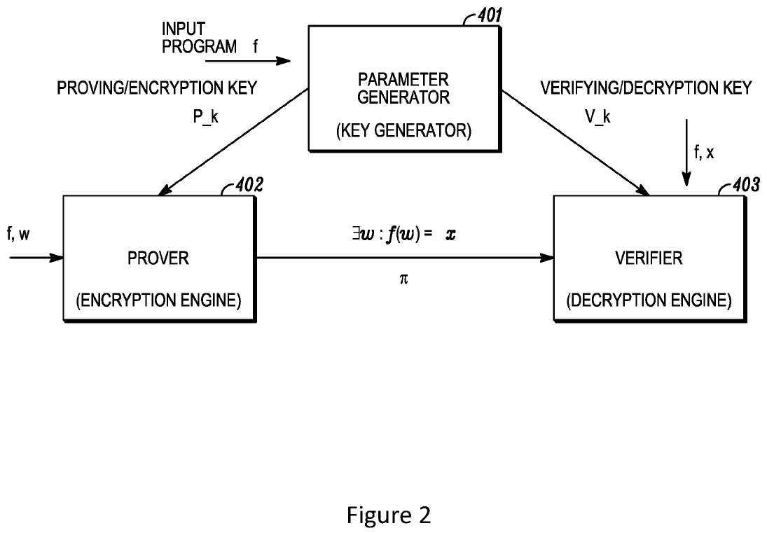

A (private key) variant of the above scheme called the proof of zero knowledge protocol (cf. D. Genkin et al., Privacy in Decentralized Cryptocurrencies, Comm. Of the ACM 61.6, 2018, pg. 78-88, which is hereby incorporated by reference in its entirety), is illustrated in FIG. 2. As shown, the cryptographic transaction computer program ƒ is provided as an input to a key generator 401. The key generator 401 produces an encryption key Pₖ (also called the proving key) and a decryption key (also called the verifying key), Vₖ.

The encryption key Pₖ is provided to an encryption engine 402 and the decryption key is provided to a decryption engine 403.

The encryption engine 402 may be described as a computer program that takes as input a program (which may or may not be a cryptographic transaction computer program), say ƒ, the encryption key, Pₖ, and the input w to the computer program ƒ. It runs the program ƒ on input w and produces a pair (x, π) as its output where x is the output of the program ƒ and π is a (cryptographic) proof of the execution of the program ƒ. If, for instance, ƒ is a cryptographic transaction program of the type described above and w is the spending right, the output x is a cryptographic coin or token.

A decryption engine 403, using the decryption key, V_{k,} verifies the proof π of the assertion ∃wƒ(w)=x. (The engine reports “true” if verification succeeds; else it returns “false”.) The soundness of the scheme asserts that the Probability[ [symbol] w:ƒ(w)=x] is negligible. The zero-knowledge assertion is that the decryption process does not yield any information, at least none that could not be inferred by other non-cryptographic means. (Trivially, output x may be asserted in the clear.)

In some embodiments, the decryption key V_{k,} may be provided to a distributed ledger such as a blockchain system for storage. In such a case, the decryption engine may retrieve the stored decryption key as needed to verify a proof presented to it.

The cryptographic techniques described above that convert spending rights into a verifiable cryptographic credential for performing transactions involving cryptocurrencies may also be used to capture user information and convert them into cryptographic credentials that are inscrutable. When shared with third parties the cryptographic credential may be verified by the recipients (or agents acting on behalf of the recipients) without recourse to the underlying user information. As a simple example, a consumer's date of birth data may be converted into a cryptographic credential that asserts that the consumer is more than 18 years old. This cryptographic credential may then be transmitted to a third party who is then enabled by the cryptographic technology to verify the received cryptographic credential without possessing the originator's date of birth data. Such techniques were collectively labeled as selective anonymity techniques in the co-pending U.S. patent applications cited above.

To illustrate the use of this technique to generate the aforementioned cryptographic credential that asserts that the consumer is more than 21 years old, assume that the computer program ƒ, instead of being a cryptographic transaction program as described above that is used to generate a coin or token, is a simple program that takes a user's date of birth as input w and computes if the user's age is greater than 21 by subtracting the current date from the input date of birth and verifying the result to be greater than 21 years. Those of ordinary skill in the art are well versed in writing programs of this type.

The program ƒ is now used as the input to the key generator 401, which produces an encryption and decryption key. The program ƒ and the input date of birth, w, are input to the encryption engine 402, which produces plaintext output x and a cryptographic proof, π, of the execution of the program ƒ. The user may now present (x, π) as the cryptographic credential asserting that his age is greater than 21 without, in fact, revealing his date of birth (i.e., the secret, w) to any third party who may verify the cryptographic credential by recourse to the decryption engine 403, which in some cases may be maintained and operated by a decryption service. That is, the cryptographic credential (x, π) comprises the assertion x (viz., that program ƒ, using an unknown input w, ran and produced the statement x) and the proof π of that alleged execution of ƒ.

It is also important to observe that since the encryption engine encrypts the computer program ƒ, the soundness property guarantees that the program ƒ was unchanged, or else the proof π could not have been verified. We refer to this as the provenance of the program ƒ being guaranteed by the soundness property of the cryptographic scheme.

It is important to understand what is entailed by verifying a proof π in the context of a program ƒ that converts user information into a cryptographic credential. A party verifying such a proof π does not know w (which is the user information held in secret by the user) but believes that a program ƒ executed on the unknown input produced the assertion x as output and that π is a proof of the alleged execution of ƒ. That is, the believer cannot in good faith believe in the validity of w; for all he knows, the user may have lied about his date of birth, w, in the above example. But he can believe, on mathematical grounds, the alleged execution of the program ƒ if the proof π can be verified. Thus, the trust model requests belief in the execution of the computer program ƒ. To trust the input w to ƒ as being valid, we must look to the program ƒ as checking the validity of its input w. For example, if the program ƒ were to be run on a credential or other input data provided by the Motor Vehicle Agency or other government agency, or if ƒ is designed to check the validity of w, e.g., by checking for identification data provided by the Motor Vehicle Agency, then the believer may find w more trustworthy.

Thus, the believer is justified in possessing varying degrees of trust based on the capabilities of programs such as ƒ. Proof of execution of a program that checks for the validity of the underlying input data w (e.g., a credential such as a driver's license issued by a government agency or issued by a third party) is more trustworthy than proofs of programs that accept unvalidated input data from users, all else being equal. This is completely realistic since people have many types of credentials in their lives, some of which may be acceptable and some not at different places and by different parties.

In summary, a cryptographic credential is a pair (x, π) resulting from the execution of a program, say ƒ, on input data, say w, where x, is the output of the program and π is a cryptographic proof of the execution of program ƒ. The actual nature of x will depend on the particular program ƒ. If, for instance, ƒ is a cryptographic transaction program that performs a transaction on a spending right, then the output x is a cryptocurrency coin or token. In other cases ƒ may be a program that operates on various types of information (e.g., sensor information, user-specific information such as government issued credentials and biometric data, etc.) that serves as input data and produces an output x that represents an assertion that accurately reflects the underlying input data without revealing the underlying data.

In some embodiments a cryptographic coin or token may be generated that includes two (or more) components. One component may represent a spending right and a second component may be an assertion that accurately reflects underlying input data without revealing the underlying data. Each component may have its own proof π associated with it. Stated differently, the coin or token may be a data object that includes one cryptographic credential (x1,π1) representing a cryptocurrency having a spending right x1 and another cryptographic credential (x2,π2) having an assertion x2 representing or reflecting underlying data such as user data. The former cryptographic credential may be referred to as a spending right or payment cryptographic credential and the latter cryptographic credential may be referred to as a user data cryptographic credential.

Furthermore, both the above credentials may be “linked” together by a third proof ensuring that the user data and the spending right pertain to the same coin. That is, coin((x1,π1), (x2,π2)), π3).

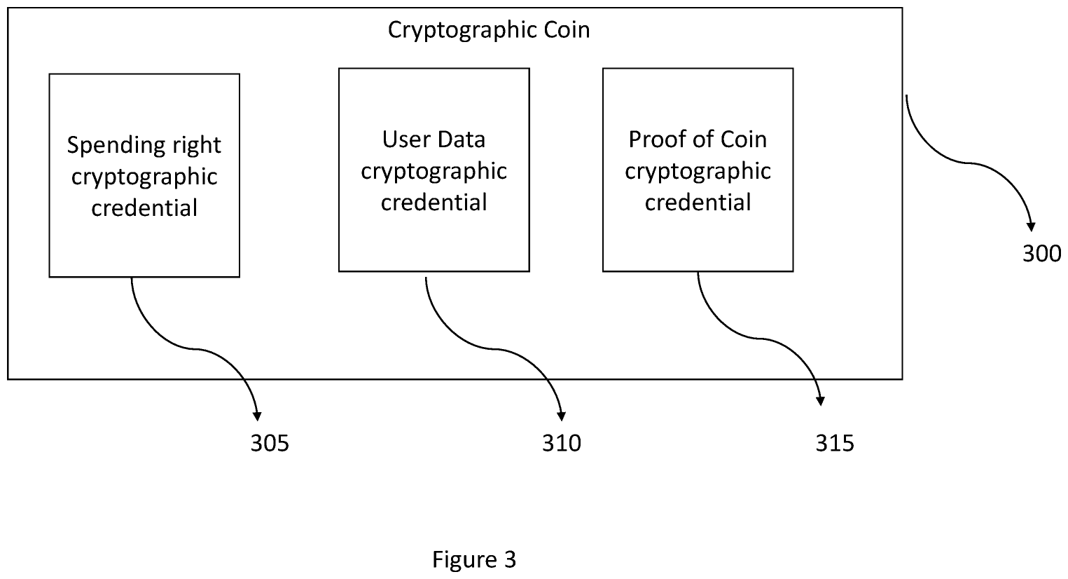

FIG. 3 shows an exemplary cryptographic coin 300 comprising a spending right cryptographic credential 305 and a user data cryptographic credential 310. In addition to the individual cryptographic credentials that make up the cryptographic coin 300, the coin 300 itself is produced as the output x of another computer program. Thus, the coin 300 also includes a proof of coin 315 that verifies the execution of the computer program that produced the coin 300 that encapsulates the spending right cryptographic credential 305 and the user data cryptographic credential 310.

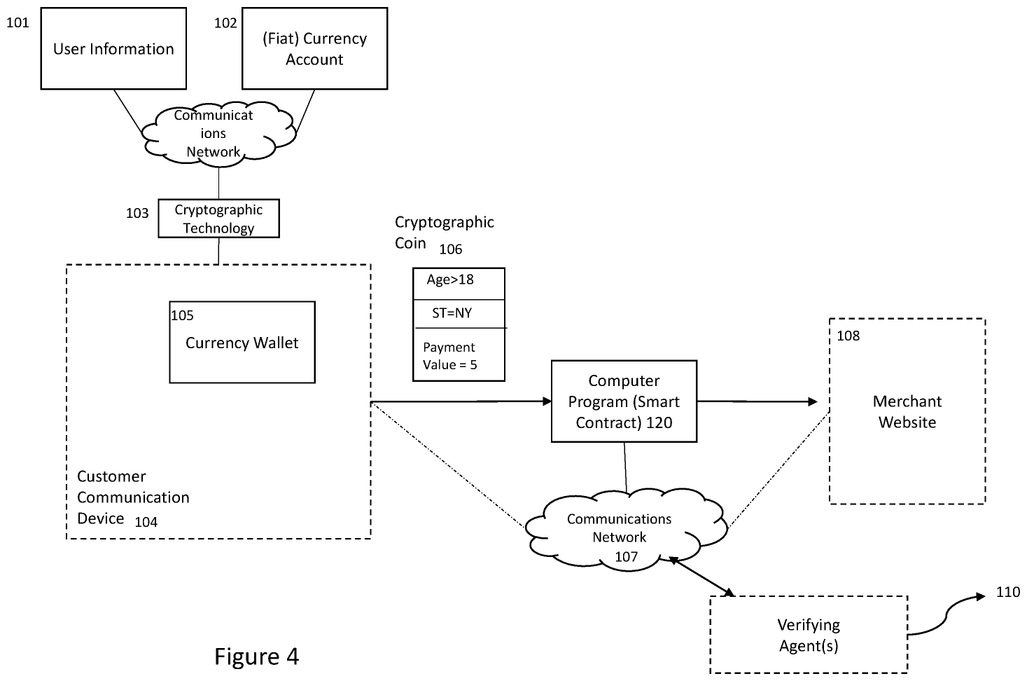

FIG. 4 shows one particular implementation of the environment of FIG. 1 in which the cryptocurrency that is employed is based on the coins or tokens described above in which spending rights are incorporated in verifiable cryptographic credentials. Similar to the environment of FIG. 1, FIG. 4 shows a user or user communication device 104 that may engage with a merchant device 108 (e.g., a merchant website or POS terminal) over one or more communication networks 107. The user communication device 104 includes a digital currency wallet 105. In this example a smart contract 120 is used to implement the functionality of the payment service 108 shown in FIG. 1 in order to facilitate the transaction between the customer and merchant. Of course, in other implementations the functionality of the payment service 108 may be implemented by other means, both automated and manual.

The digital currency wallet 105 may be provisioned with cryptocurrency before the transaction with the merchant device 108 is to take place or at the time of the transaction. In either case, the customer, using digital currency wallet 105, causes selected user information 101 associated with the user and spending rights contained in a fiat currency account 102 (e.g., a U.S. dollar denominated bank account) to be converted into a cryptographic coin or token 106 using the cryptographic techniques described above and which are represented generally in FIG. 7 by cryptographic technology 103. As shown, in this example, the cryptographic coin or token 106 includes three components: a first user data cryptographic credential asserting that the customer is older than 18 years of age, a second user data cryptographic component asserting that the customer is a resident of New York State, and a third payment cryptographic component representing a spending right having a value of 5. Of course, as discussed above, the coin or token 106 may have any number of components with any combination of spending rights and/or user data components.

Upon receiving the coin or token 106 from the user communication device 104, the smart contract 120 may communicate the received coin to one or more service providers referred to as verifying agent(s) 110. Verifying agent(s) 100 may be provisioned with the decryption engine 403, decryption key Vₖ and program ƒ shown in FIG. 2 so that it can verify the cryptographic credentials in the coin or token using the techniques described above. Once verification as to the authenticity of the coin's information has been received from the verifying agent(s) 110, the smart contract 120 may proceed with transferring the coin or token 106 to the merchant website 108.

In most practical applications, the verification requests are aggregated into a “block” and verified en masse. For reasons of simplicity and without loss of generality we assume in the current presentation that a block contains a single verification request.

Clearly, the validity of transactions depends on the integrity of the verification agents that are employed since a verification request may be received by a malicious agent who may then proceed to report “success” for an invalid transaction. Thus, a response to a verification request must engender trust in all the parties. This is usually referred to as reaching consensus amongst the various network entities.

Considerable effort has been expended in solving the consensus problem and various schemes have been proposed. Presented herein is a method by which consensus may be reached. The method offers fast execution times with low latency and high throughput. Certain elements of the method are computationally lightweight and thus may be executed by user communication devices. This affords the opportunity for users to earn transaction fees by offering their user communication devices to act as verification agents. More importantly, the users thus may become more vested in the integrity of the network. Finally, the consensus method does not require inordinate computing effort and is thus efficient in its use of computational resources.

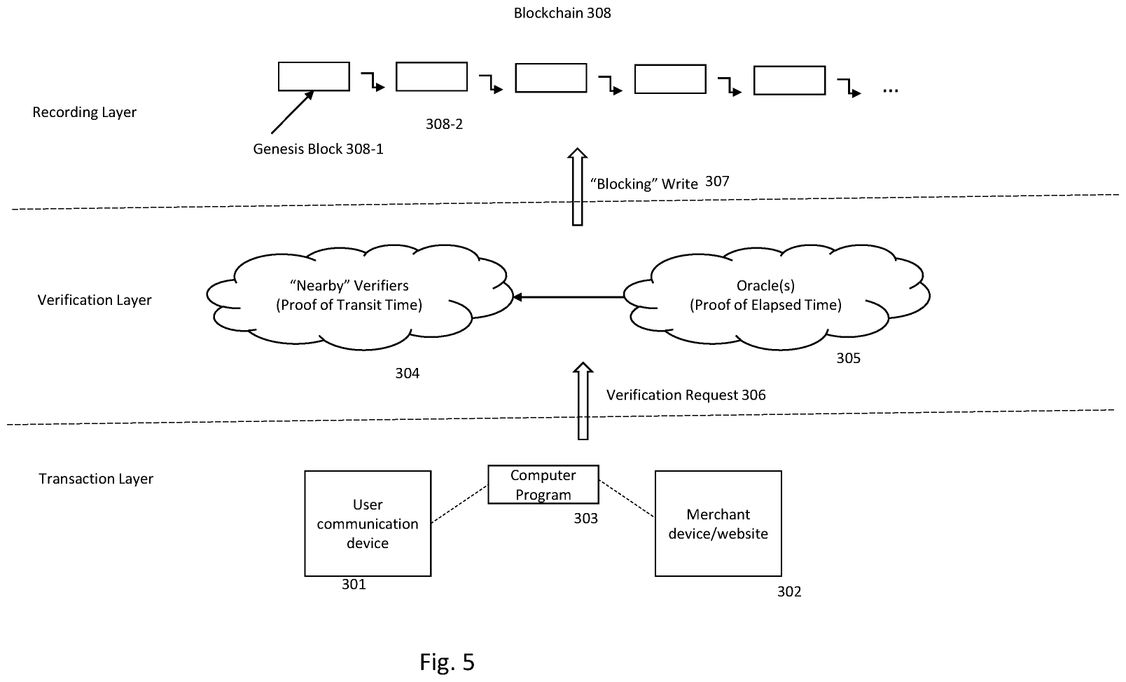

FIG. 5 shows one example of an operating environment in which the consensus techniques described herein may operate. A user communication device 301 (generally equipped with a suitable application such as a digital wallet) initiates a transaction with the merchant device 302, which in this example executes under the programmatic control of smart contract 303. This is the so-called two-legged transaction model described above. More generally, any transaction model may be employed which may or may not employ smart contracts. In this example, the smart contract 303 issues a verification request 306. In other examples the verification request may be issued by the merchant device 302 or other entity. User communication device 301, merchant device 302 and smart contract 303 may be collectively referred to as comprising the transaction layer of the operating environment.

The verification request is received by a series of nodes that define a network 305 which, after processing, forward the verification request to the nodes that define another network 304. For reasons that will be become clear below the network 305 will be referred to as an elector network 305 comprising a series of elector nodes and the network 304 will be referred to as a verifier network 304 comprising a series of verifier nodes. The verifier nodes of the verifier network 304 and the elector nodes of elector network 305 may collectively be said to comprise the verification layer of the operating environment. For purposes of illustration the nodes of the elector and verifier networks will be illustrated as disjoint. However, in other implementations, described in more detail below, certain nodes may function as both elector nodes and verifier nodes, assuming they incorporate suitable virtual machines or other controlled programming environment for an application program that isolates the application program from certain details of the host machine. In general, the elector nodes and verifier nodes may be any suitable devices that have sufficient hardware and software capabilities to implement their required functionality as described below. In one particular embodiment, for instance, this requires that the devices used as elector nodes to be able to execute the proof of elapsed time (PoET) algorithm described below and the devices used as verifier nodes need to be able to execute the proof of round trip time (PoRTT) algorithm described below.

As explained in more detail below, the elector nodes receive the verification request 306 from the transaction layer and select one of the verifier nodes. The selected verifier node then verifies the transaction associated with the verification request.

Once the incoming transaction request has been verified by the verifier nodes, the verification layer may transmit a write request 307 to the blockchain 308. The latter may be described as a data structure that allows new entries to be appended to it but in which pre-existing entries cannot be edited or deleted. The entries recorded in the blockchain relate to information about the verified transactions. Typically, entries are grouped into blocks 308-1, 308-2, etc., and the first such block is referred to as the genesis block, 308-1. (The term “blocking write” refers to the property that a write operation on a first block needs to be completed before a write operation on a second block can be initiated, i.e., blocks of verified transactions are to be appended to the blockchain one at a time.) In subsequent discussions, for the sake of simplicity and without loss of generality, we assume each block of the blockchain consists of a single entry corresponding to one transaction. That is, we assume a block size of 1. Conventional practice typically uses block sizes of 1-2 thousand transactions. It should be noted that recording of the verified transaction in the recording layer is optional and may not be employed in all implementations.

In addition to recording a verified transaction in a block of the blockchain and appending the block to the blockchain, a confirmation is also sent to the appropriate entity in the transaction layer via the elector network.

As has been stated above, it is crucial that consensus is reached amongst all network entities as to the validity of verifications. That is, it is important that all network entities trust the result of verifications as being valid. Said another way, the verification method must ensure that it is sound and complete.

Soundness of the verification method means that no invalid transaction is deemed verified by the verification method. Completeness of the verification method means that all valid transactions are verified by the verification method. Sometimes, in practice, a verification method may provide a probabilistic rather than an absolute guarantee. For example, a probabilistic soundness guarantee implies that an invalid transaction may be verified with a finite, albeit small, non-zero probability.

In some embodiments, the verification method performed by the nodes in the verification layer of FIG. 3 proposed herein includes the following three phases.
1. An Elector Node Phase in which a first consensus decision-making algorithm (the PoET algorithm) is used to select one of the elector nodes in elector network 305 as a leader.
2. A Verifier Node Phase in which a verifier node of the verifier network 304 is selected by the leader of the elector network 305 using a second consensus decision-making algorithm (e.g., a PoRTT algorithm). The selected verifier node verifies the transaction
3. An M-of-N (M<N) Proof of Authority Phase in which additional verifier nodes of the verifier network 304 verify the proposed verification of the transaction, which was performed by the verifier node selected by the leader of the elector network 305.

### Elector Node Phase

As previously mentioned, the elector node phase is implemented by elector nodes that make up elector network 305. These nodes may be any suitable devices that are equipped with a processor the necessary hardware and software that allow it to implement the first consensus decision-making algorithm. For instance, in some implementations the elector nodes may be a collection of servers, other network components, or even user communication devices that in some cases are also able to participate in the transaction process and hence are also members of the transaction layer.

Proof of Elapsed Time (PoET) is a consensus algorithm developed by Intel that eliminates the computationally intensive resources required by the original proof-of-work consensus algorithm and thus also eliminates the wasteful energy consumption associated with the original proof-of-work consensus algorithm. In PoET, each elector node is assigned a random wait time sampled from an exponential distribution, generated by code running inside a trusted execution environment (TEE) of the elector node. TEEs provide secure areas of a processor that protect application level code even from processes running at a higher privilege level. TEEs are generally equipped with cryptographic verification procedures that can provide externally verifiable attestations and tamper evidence. One such TEE, with which PoET was initially developed by Intel and which in some embodiments may be employed by the elector nodes in the present invention, is Intel's Software Guard Extension (SGX) technology. One particular example of the PoET algorithm that may be employed in the techniques described herein conforms to the PoET 1.0 Specification and any later developed versions thereof. Of course, any suitable variants of the PoET Specification may be employed as well.

The random wait times in the PoET may instruct a verifier node to go to sleep for an interval of time based on a randomly generated number. A collection of such nodes thus goes to sleep, and each node wakes up at random time instants. The sleep intervals may be arranged to lie within a pre-determined time interval, say 1 second, for instance. That is, in this example, all nodes in the network will go to sleep at 1 second intervals. Each node wakes up at a random instant of time (within 1 second). The first node to wake up is selected and referred to as the leader node.

Two key features of the PoET algorithm ensure that a malicious device cannot be chosen as the leader node. First, the TEE can create a certificate that allows the code executing the algorithm to be considered reliable. This feature allows a node to demonstrate to other participating nodes that it is executing reliable and correct code. The second feature is that the TEE provides a storage space for the code that cannot be interfered with. This prevents a malicious entity from manipulating the code to cause the selection of a malicious device as the leader.

### Verifier Node Phase

As previously mentioned, the verifier node phase is an example of a consensus decision-making algorithm that is implemented by verifier nodes that make up verifier network 304 and which verify the aforementioned cryptographic credentials. As previously mentioned, the verifier nodes may be any suitable devices that are equipped with a processor the necessary hardware and software that allow it to implement a consensus decision-making algorithm of the type described below. Because the verification process is a polynomial time process and hence is an efficient and computationally lightweight problem, in some embodiments the individual verifier nodes may be user communication devices (e.g., smartphones) that communicate over one or more wired or wireless networks such as a cellular network and/or the Internet, for example. In some cases, the same user communication devices that perform transactions in accordance with the techniques described herein may also serve as verifier nodes for other transactions in which they do not otherwise participate.

The elector node L that was selected as the leader of elector network 305 forms a group of verifier nodes and randomly selects one member of that group to verify the transaction. The group may be dynamically formed by the leader node L when the transaction is to be verified and generally will contain different members each time a transaction is to be verified. The members of the group of verifier nodes may be selected by the leader node L using a consensus decision-making algorithm that does not allow the members to be selected based on the behavior of any single verifier node. Rather, the technique should depend on the behavior of the various nodes of the verifier network 304 and/or the infrastructure (e.g., switches, routers, links) of the network 305, thereby preventing the selection of the members from being determined by any single entity.

In general, the leader node L that selects the members of the verifier group of verifier nodes will use a consensus decision-making algorithm that performs the selection process based on some dynamically varying and ascertainable characteristic of the verifier nodes. For instance, in one embodiment in which the verifier nodes are devices that communicate over a cellular network, the characteristic may the distance between the mobile communication device and its nearest cellular base station. For instance, all mobile communication devices that are within some specified range of their nearest cellular base stations may be chosen as members of the verifying group.

Alternatively, another characteristic of the verifier node that may be used by the consensus decision-making algorithm is the round-trip-time (RTT) of a signal that is sent to the verifier node from a common entity. The RRT time is the total time taken to send the signal to the verifier node plus the time taken to receive a response to that signal. If the signal that is sent is a data packet, the RTT is also known as the ping time. The common entity that determines the RTT of the verifier nodes may be any suitable entity that is able to build and update a table or the like of the RTTs of the devices in the verifying network, which can then be accessed by the leader of the elector network. In some cases this entity may be, for example, a network server that tracks and records the RTTs. In some embodiments the entity may publish a list of verifier nodes that fall into different PoRTT groups, e.g., PoRTT 100 ms group, PoRTT 200 ms group, etc. Each entry in the table can specify the verifier nodes belonging to that group. The selection of verifier node based on the RTT is referred to as an example of a PoRTT consensus decision-making algorithm. In one particular implementation that employs the PoRTT algorithm, the verifier nodes may be mobile communication devices such as user communication devices that also participate in transactions that are to be verified.

If the PoRTT consensus decision-making algorithm is employed by the leader node to select the members of the verifying group, then the leader node L may select as members all verifying nodes that have RTTs falling within some predefined range (e.g. 3-5 milliseconds) at the time the group is to be formed. The leader node L can make this selection with reference to the previously mentioned table or the like that maintains the current RTTs of the verifying nodes. In practice, several such groups may be formed for different ranges of RTT values. In some cases the size of the groups may also be pre-determined by one or more additional parameter.

### M-of-N (M<N) Constraint

The M-of-N constraint requires that at least N members of a verifying group of M verifier nodes adhere to the stated constraint. In verification networks, the M-of-N constraint typically requires that M of N members of a group verify a proposed verification.

### Illustrative Method

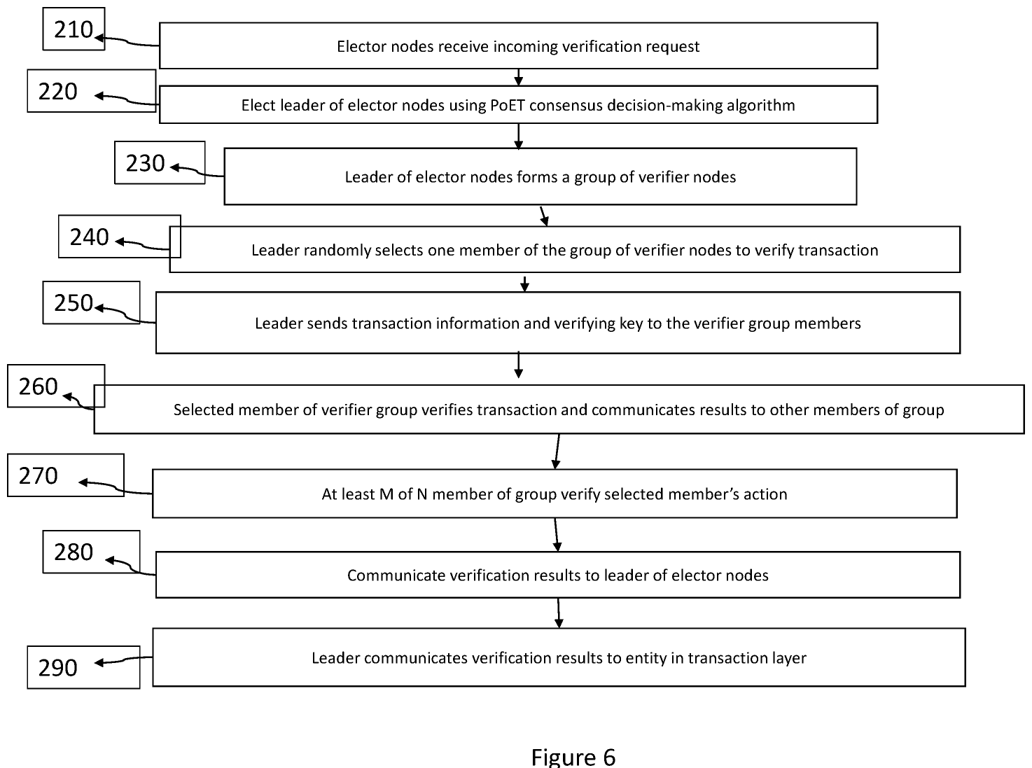

FIG. 6 is a flowchart illustrating one example of a method for verifying a transaction between a user communication device and a third party. At block 210, an incoming transaction verification request is received by the elector nodes from an entity involved in a particular transaction between a user communication device and a merchant device such as a merchant website or POS terminal, for example. Thus, the transaction verification request may be received from the merchant device or a smart contract that facilitates the transaction, for instance. The incoming transaction verification request that is received may be stored in a queue until it is ready to be processed.

When the transaction is to be processed a leader is elected at block 220 from among the elector nodes using, for example, the previously described PoET consensus algorithm. At block 230, the leader node of the elector nodes forms a group of verifier nodes with a predetermined number of members. In one embodiment the members of the group of verifier nodes are mobile communication devices that are selected based on the RTT of signal that is sent to from a given entity using the previously mentioned PoRTT consensus algorithm. The leader may refer to a table of RTTs maintained by the entity in order to select as members of the verifier group verifier nodes that have RTTs within a specified range of times (e.g, 3-5 msecs).

Next, at block 240, the leader node randomly chooses one member of the verifier group to verify the transaction in the transaction request. In some cases the leader may be constrained to prevent it from selecting certain members of the verifier group as the node that verifies the transaction. For example, in some cases only a member that has not been previously chosen within some predetermined period of time, or within the current cycle (defined below), may be chosen. At block 250 the leader sends the pertinent transaction details (e.g., the cryptographic coin) and the verifying key to the members of the verifier group.

Next, at block 260 the selected member X of the verifier group formed by the leader verifies the associated with transaction request and communicates its decision to the other members of the group. At least M of the N members of the verifier group verify X's action at block 270. The results are then communicated to the leader and optionally recorded in a blockchain or other recording mechanism in a recording layer at block 280. The leader, in turn, communicates the verification results to the entity in the transaction layer that requested the verification at block 290.

In some embodiments that employ the PoRTT algorithm to select the group of verifier nodes, when contacting (e.g., pinging) the nodes with a signal to measure the RTT, the nodes may be required to evaluate a random function, e.g., add two randomly generated integers and return the result. This ensures that the node actually performs computational work so that it may not anticipate the incoming signal and game the system.

In some embodiments, the leader of the elector network may require all members of the group of verifier nodes to verify the given transaction. The leader may then deem the transaction to be verified if a majority of the verifier node group successfully verifies the transaction. This method of evaluation may be referred to as “proof by voting.”

In some embodiments, the group of verifier nodes that is formed by the leader of the elector network may be used to verify multiple transactions rather than being formed for the purpose of only verifying a single transaction. In this case a sliding or cyclic approach may be used in which each member of the verifier node group is sequentially chosen to verify the transaction while the remaining members verify the chosen member's action as part of the M-of-N constraint. The cycle is complete when all members of the verifying group have been chosen to verify the transaction. The group may be disbanded after a single cycle or after multiple cycles.

In some embodiments the PoRTT and PoET algorithms for selecting verifier nodes and the elector nodes, respectively, may be used independently of one another. That is, in some cases one these algorithms, say the PoRTT algorithm for selecting verifier nodes, may be used with some consensus decision-making algorithm other that the PoET algorithm for selecting elector nodes. Likewise, in other cases the PoET algorithm for selecting elector nodes, may be used with some consensus decision-making algorithm other that the PoRTT algorithm for selecting verifier nodes.

In some embodiments the verifier nodes do not themselves perform the acts required to verify the transaction. Rather, every verifier node may be associated with a proxy cloud server. In this case the proxy cloud server for the verifier node X that is selected by the leader elector node performs the verification process. Similarly, members of the group of verifier nodes formed by the leader elector node may not verify the actions of the verifier node X. Rather, their respective proxy cloud servers may verify those actions. The use of proxy cloud servers in this manner may impose less stress on the resources of the verifier nodes, which may be of particular importance when the verifier nodes are wireless user communication devices. At the same time, the verifier nodes may earn transaction fees for participating in the verification processes, which again may be particularly important when the verifier nodes are wireless user communication devices.

It should be noted that the use of the PoRTT consensus decision-making algorithm introduces the idea of using network parameters, such as RTT, or number of hops, etc., to calculate random numbers based on data generated by a decentralized collection of network elements, i.e., routers, switches, etc. Since these network parameters and their values are generated by network protocols running on a decentralized collection of machines and the values of the parameters may not be tampered with by user/application level commands, the network parameters/values may be used to create randomization algorithms and used in consensus methods of cryptographic systems.

In some of the embodiments discussed above, the execution of certain types of computer programs that generate cryptographic spending rights in trusted execution environments have been considered. The spending rights so generated can be “trusted” since the spending rights are associated with proofs of the execution of those computer programs on inputs of previously received spending rights. (The previously received spending rights, in turn, are trusted because of previously generated execution of programs, the trust is based on a series of “linked” proofs.)

In an alternative embodiment, any type of computer programs may be so executed, and their executions may be associated with proofs of their execution on certain specific inputs. Using the terminology of FIG. 2, such proofs may be tantamount to the statement “Program ƒ ran on input w and produced output x”. In particular, the program ƒ may be constructed in such a manner as ascertaining the validity or the provenance of the input w.

If now the program ƒ ran and terminated without raising an error condition, then it may be asserted that the proof associated with the execution of the program ƒ also serves to verify the validity of the input or the provenance of the input.

For example, we may construct program ƒ to verify the source or provenance of the input dataset to ensure that the input dataset is what it purports to be (e.g., a valid driver's license issued to John Doe by the Motor Vehicle Bureau (MVB) of the state of New Jersey). In some embodiments this may be accomplished using a unique serial number or other identifier that the source (e.g., the MVB) of the input dataset has provided and associated with the input dataset. The program ƒ may then check the identifier to confirm the source or provenance of the underlying dataset and that the underlying dataset is what it purports to be. The proof associated with the execution of the program ƒ may then be taken to also verify the source or provenance of the underlying dataset to the program ƒ. An output of the program ƒ when provided to a third party may then be said to comprise a proof of the execution of the program and the verification of the input dataset.

Note that since a third-party receiving proof of execution of a program and its outputs never sees the input dataset, i.e., the secret w, it may now be further assured that the output is based on verified inputs. Thus, the provenance of the inputs may be verified as well.

### Illustrative Computing Environment

As discussed above, aspects of the subject matter described herein may be described in the general context of computer-executable instructions, such as program modules, being executed by a computer. Generally, program modules include routines, programs, objects, components, logic, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

1. A method of verifying a transaction between a user communication device and a third party, comprising:
receiving a request at each of a plurality of elector nodes to verify a transaction;
selecting a leader node from among the elector nodes using a Proof of Elapsed Time PoET consensus decision-making algorithm in which each of the elector nodes is assigned a random wait time, the leader node being a first of the elector nodes whose wait time is exceeded;
using the leader node to select a subset of verifier nodes from among a plurality of verifier nodes in accordance with a second consensus decision-making algorithms different from the PoET consensus decision-making algorithm;
using the leader node to select a given verifier node from among the subset of nodes; and
causing the given verifier node to verify the transaction.

2. The method of claim 1, wherein the second consensus decision-making algorithm is a Proof of Round Trip Transit Time (PoRTT) consensus algorithm in which the verifier nodes in the subset of verifier nodes are selected based on a round trip time of a signal sent to teach of the verifier nodes in the plurality of verifier nodes.

3. The method of claim 2, wherein the verifier nodes in the subset of verifier nodes are selected which have respective round trip times that are within a specified range.

3. The method of claim 1, wherein verifying the transaction includes verifying that a cryptographic coin exchanged during the transaction was produced by a proof of zero-knowledge protocol using specified service logic.

4. The method of claim 3, further comprising causing the cryptographic coin and a decryption key generated in accordance with the proof of zero-knowledge protocol to be provided to the given verifier node so that the given verifier node is able to verify the transaction.

5. The method of claim 1, further comprising causing remaining ones of the verifier nodes in the subset of verifier nodes to confirm the verification of the transaction by the given verifier node.

6. The method of claim 5, further comprising causing the cryptographic coin and a decryption key generated in accordance with the proof of zero-knowledge protocol to be provided to each of verifier nodes in the subset of verifier nodes to thereby allow the verifier nodes to verify the transaction.

7. The method of claim 1, wherein the elector nodes in the plurality nodes include a plurality of wireless user communication devices.

8. The method of claim 1, wherein verification of the transaction includes verification that a specified program was executed using underlying information without verifying underlying information.

9. The method of claim 8, wherein the underlying information is associated with an identifier and verification that the specified program was executed using underlying information without verifying underlying information includes verification that the specified program used the identifier to confirm a source or provenance of the underlying information.

10. The method of claim 1, wherein the transaction includes a transfer of a cryptographic credential generated using a proof of zero-knowledge protocol.

11. The method of claim 10, wherein the cryptographic credential includes a cryptocurrency component.
